(19) United States
(12) Patent Application Publication
(10) Pub. No.: US 2019/0213650 A1
(43) Pub. Date: Jul. 11, 2019

(54) FOOD ORDER RECEIVING AND PLACING SYSTEM

(71) Applicant: Paula Babich, Davie, FL (US)

(72) Inventor: Paula Babich, Davie, FL (US)

(21) Appl. No.: 15/866,668

(22) Filed: Jan. 10, 2018

(51) Int. Cl. G06Q 30/06; G06Q 50/12; G06F 3/0488; G06F 3/0482; G06F 1/16

(52) U.S. Cl. CPC G06Q 30/0603; G06Q 50/12; G06F 1/1626; G06F 3/0482; G06F 3/0488

(57) ABSTRACT

A food order receiving and placing system includes a hub for wirelessly receiving food order information and printing the food order information. Each of a plurality of input assemblies is portable and self-contained and includes a touch screen including a plurality of food menu selections. The food menu selections are selectable on the touch screen and selected food menu selections are converted to food order information by the input assemblies. Each of the input assemblies sends associated ones of the food order information to the hub.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention

### (2) Description of Related Art including information disclosed under 37 CFR 1.97 and 1.98

The disclosure and prior art relates to food ordering devices and more particularly pertains to a new food ordering device for stream lining an ordering process from a food server to the kitchen and drink staff of a restaurant.

### BRIEF SUMMARY OF THE INVENTION

An embodiment of the disclosure meets the needs presented above by generally comprising a hub for wirelessly receiving food order information and printing the food order information. Each of a plurality of input assemblies is portable and self-contained and includes a touch screen including a plurality of food menu selections. The food menu selections are selectable on the touch screen and selected food menu selections are converted to food order information by the input assemblies. Each of the input assemblies sends associated ones of the food order information to the hub.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an input assembly for a food order receiving and placing system according to an embodiment of the disclosure.

FIG. 2 is a front view of an embodiment of the disclosure.

FIG. 3 is a front in-use view of an embodiment of the disclosure.

FIG. 4 is a schematic view of an embodiment of the disclosure.

FIG. 5 is a schematic view of an embodiment of the disclosure.

### DETAILED DESCRIPTION OF THE INVENTION

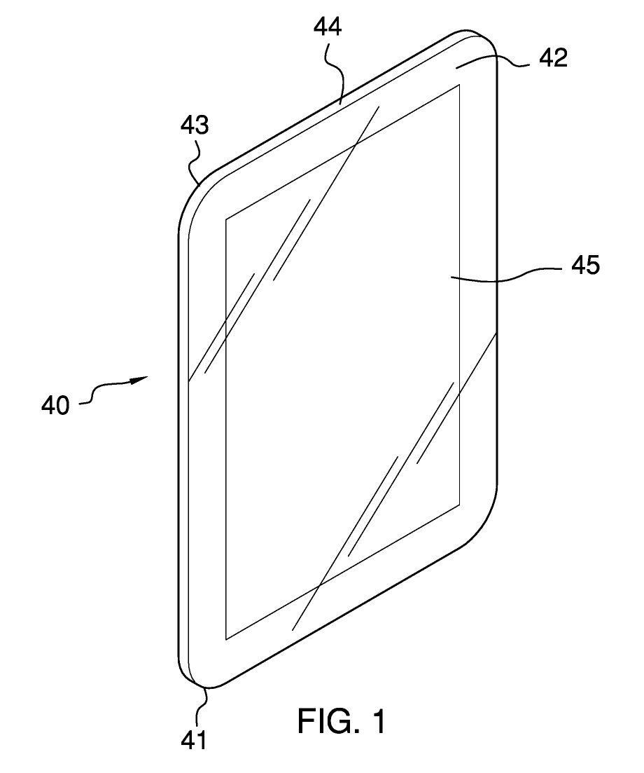

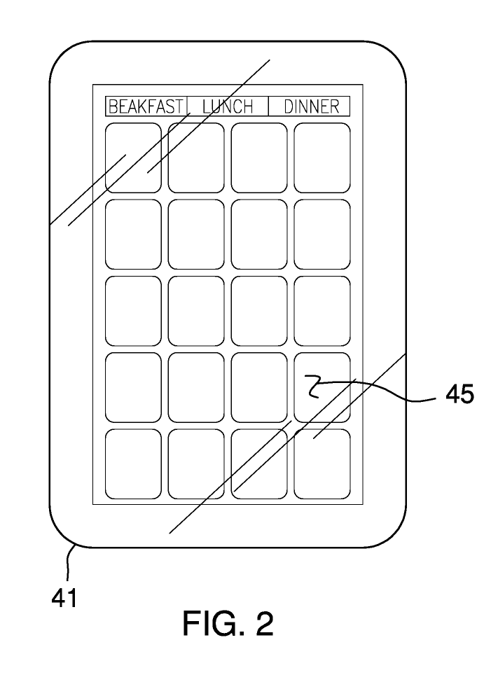

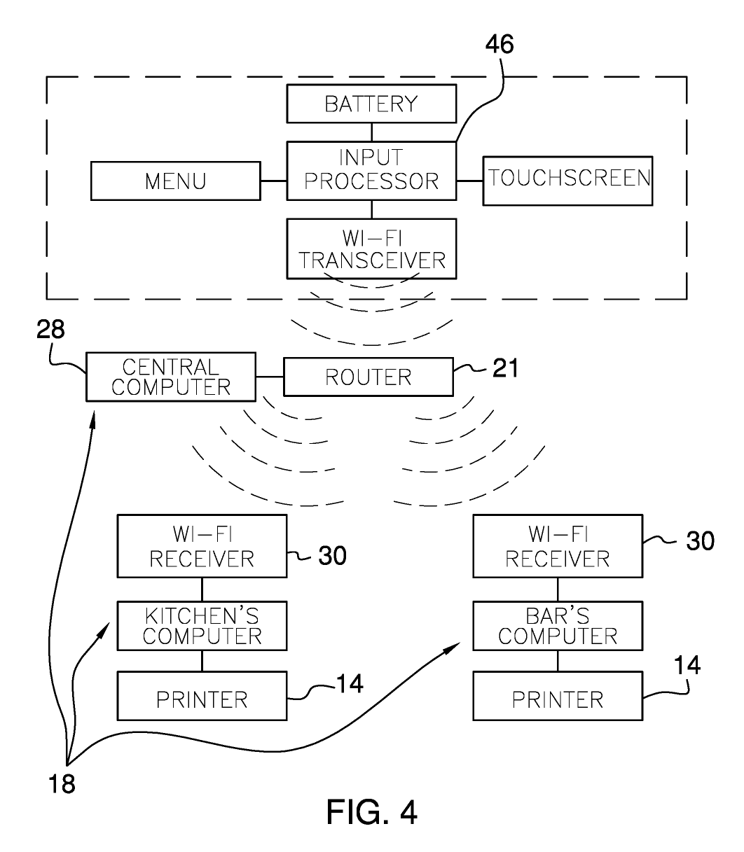

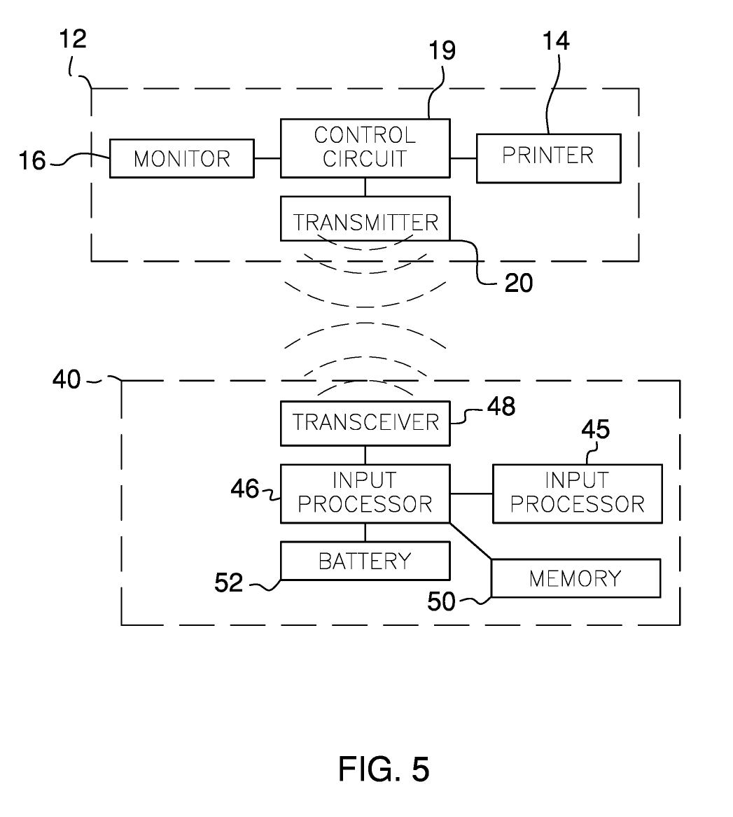

With reference now to the drawings, and in particular to FIGS. 1 through 5 thereof, a new food ordering device embodying the principles and concepts of an embodiment of the disclosure and generally designated by the reference numeral 10 will be described.

As best illustrated in FIGS. 1 through 5, the food order receiving and placing system 10 generally comprises a hub 12 for wirelessly receiving food order information and printing the food order information. The hub 12 includes a printer 14 and may further include a monitor 16 such as a conventional display screen for viewing items to be selected and printed. As such, the hub 12 may include a conventional computer 18 and will at least comprise a control circuit 19 (CPU) that is electrically coupled to the printer 14 and the monitor 16. A transmitter 20 for wireless communication is electrically coupled to the control circuit. The transmitter 20 may use conventional WiFi, Bluetooth or other similar communication protocols utilizing direct machine to machine communication or utilization of a wireless router 21 connection.

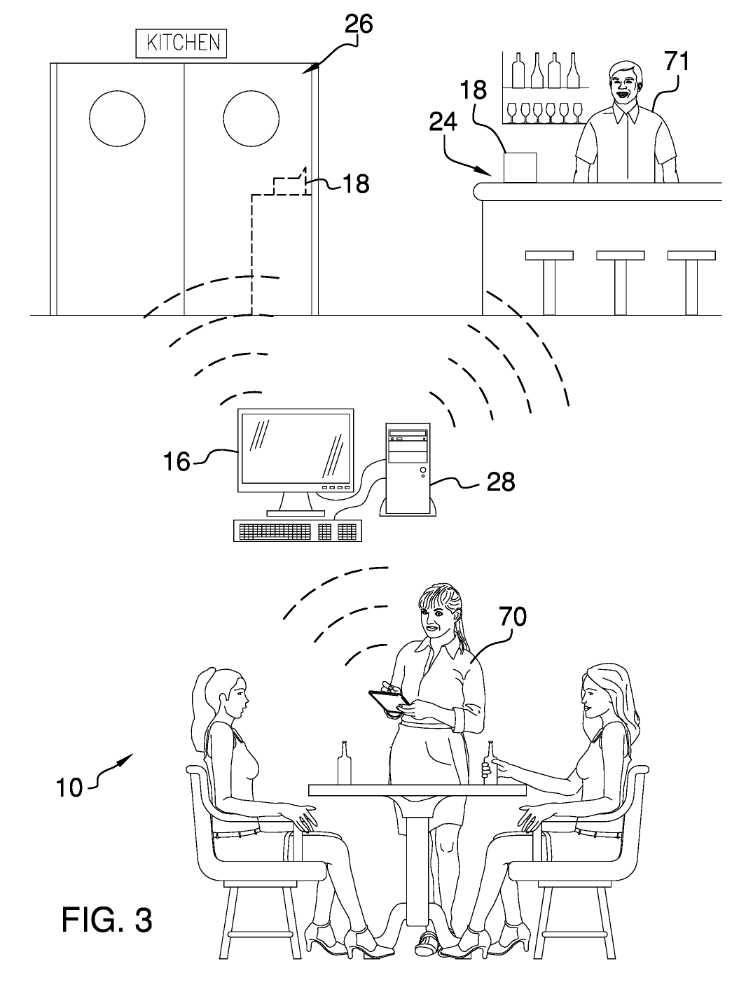

The hub 12 may include a plurality of computers 18, and each may be equipped with a printer 14, so that, for example, one computer 18 is placed at a drink area 24 within a restaurant and another computer 18 is positioned within the kitchen 26 of the restaurant. FIG. 3 depicts a version wherein the hub 12 includes a central computer 28 communicating with other printers 14 and monitors 16 of other computers 18. However, alternatively, one of the computers 18 located in the kitchen 26 or drink area 24 may, for example, serve as the central computer 28. Thus, it should be understood that the function of the hub 12 is to receive food order information and disseminate it to those persons who are in need of that particular information. As such, it may include one or multiple computers 18, though a central computer 28 may be preferred so that its data may be analyzed by a manager to determiner throughput of food order information and to have an overview of the entire system 10. If a central computer 28 is used, it may not include a printer 14 and may further be in wireless communication via a router to the other computers 18 and with the internet for remote monitoring and control of the system 10. Furthermore, the computers 18, apart from the central computer 28, may include only a receiver 30 as opposed to a transmitter 20 and may further be without a monitor 16 as its only function is to print food order information.

A plurality of input assemblies 40 is provided. Each of the input assemblies 40 is portable and self-contained. The term “self contained” is defined to mean that the input assemblies 40 are not tethered to other electronic devices and are easily carried by a user of such and may include what are known as “notepad computers” having a size which may allow them to be extended into a pocket. Each of the input assemblies 40 includes a housing 41 that has a front wall 42, a back wall 43 and a perimeter wall 44 attached to and extending between the front 42 and back 43 walls. The housing 41 has a length and width each is less than 12.0 inches and a depth is less than 0.5 inches. A display screen 45 is mounted in the front wall 42 and the display screen 45 may occupy at least 80% of an area of the front wall 42. The display screen 45 may preferably comprise a touch screen. An input processor 46 is mounted in the housing 41 and is electrically coupled to the display screen 45. A transceiver 48 is mounted in the housing 41 and is electrically coupled to the input processor 46. An electronic memory 50 is mounted in the housing 41 and is electrically coupled to the input processor 46. A battery 52, which will typically comprise a rechargeable battery, is mounted in the housing 41 and is electrically coupled to the input processor 46.

The input processor 46 is programmed with to visually display on the display screen 45 a plurality of food menu selections, a plurality of table selections and a customer indicator associated with the table selection. The food menu selections may include anything typically found on a restaurant menu including not only food items but also drinks, desserts and the like. In use then, a server 70, who is using the input assembly 40, may select a particular table, then a particular customer at that table and finally the menu selections associated with that particular customer. As an example, the server 70 would first select “table 25” and then select “customer 1.” Thereafter the server 70 would select each food menu selection “customer 1” desires and then move on to “customer 2” and repeat the selection of food menu selections until all customers at “table 25” have provided their food order.

The input processor 46 is programmed to include and store in the electronic memory 50:

1) a first step of receiving a first input comprising actuation of one of the table selections;

2) a second step of receiving a second input comprising actuation of one of the customer indicators;

3) a third step of receiving a third input comprising one or more actuations of the food menu selections associated with prior actuation of one of the customer indicators and allowing the second and third steps to be repeated; and

4) a fourth step of converting all stored actuations of the first, second and third steps into the food order information and wirelessly sending the food order information to the hub 12.

When the food order information is sent to the hub 12, the staff 71 utilizing their particular computer 18 will be able to print out the food order information and begin to prepare the required food menu selection. The hub 12, or computers 18 part of, may be programmed to automatically print out the food order information to avoid any risk that a received food order is not noticed. Also, the central computer 28 may be programmed to only send partial food order information so that only those staff 71 members requiring certain information receive it. Thus, a drink portion of the food order information would go to the drink area 24 computer 18 while the food portion of the food order information would go the computer 18 located in the kitchen 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wait staff food order processing system, said system including:
a hub for wirelessly receiving food order information and printing said food order information; and
a plurality of input assemblies, each of said input assemblies being portable and self-contained, each of said input assemblies including a touch screen including a plurality of food menu selections, wherein said food menu selections are selectable on said touch screen and selected food menu selections are converted to food order information by said input assemblies, each said input assemblies sending associated ones of said food order information to said hub.

2. The wait staff food order processing system according to claim 1, wherein said hub includes:
a monitor for displaying said food order information;
a printer;
a control circuit being electrically coupled to said printer and said monitor;
a transmitter for wireless communication being electrically coupled to said control circuit, said transmitter being in wireless communication with each of said input assemblies.

3. The wait staff food order processing system according to claim 1, wherein each of said input assemblies includes:
a housing having a front wall, a back wall and a perimeter wall being attached to and extending between said front and back walls, said housing having a length and width each being less than 12.0 inches and a depth being less than 0.5 inches;
said touch screen comprising a display screen being mounted in said front wall, said display screen occupying at least 80% of an area of said front wall;
an input processor being mounted in said housing and being electrically coupled to said display screen;
a transceiver being mounted in said housing and being electrically coupled to said input processor;
an electronic memory being mounted in said housing and being electrically coupled to said input processor; and
a battery being mounted in said housing and being electrically coupled to said input processor.

4. The wait staff food order processing system according to claim 3, wherein:
said input processor being programmed with to visually display a plurality of food menu selections on said display;
said input processor being programmed to visually display a plurality of table selections on said display; and
said input processor being programmed to visually display a customer indicator associated with said table selection.

5. The wait staff food order processing system according to claim 4, wherein said input processor is programmed to include and store in said electronic memory:
a first step of receiving a first input comprising actuation of one of said table selections;
a second step of receiving a second input comprising actuation of one of said customer indicators;
a third step of receiving a third input comprising one or more actuations of said food menu selections associated with prior actuation of one of said customer indicators and allowing said second and third steps to be repeated; and
a fourth step of converting all stored actuations of said first, second and third steps into said food order information and wirelessly sending said food order information to said hub.

6. A wait staff food order processing system, said system including:
a hub for wirelessly receiving food order information and printing said food order information, said hub including:
a monitor;
a printer;
a control circuit being electrically coupled to said printer and said monitor;
a transmitter for wireless communication being electrically coupled to said control circuit;
a plurality of input assemblies, each of said input assemblies being portable and self-contained, each of said input assemblies including:
a housing having a front wall, a back wall and a perimeter wall being attached to and extending between said front and back walls, said housing having a length and width each being less than 12.0 inches and a depth being less than 0.5 inches;
a display screen being mounted in said front wall, said display screen occupying at least 80% of an area of said front wall, said display screen being a touch screen;
an input processor being mounted in said housing and being electrically coupled to said display screen;
a transceiver being mounted in said housing and being electrically coupled to said input processor;
an electronic memory being mounted in said housing and being electrically coupled to said input processor;
a battery being mounted in said housing and being electrically coupled to said input processor;
said input processor being programmed with to visually display a plurality of food menu selections on said display;
said input processor being programmed to visually display a plurality of table selections on said display;
said input processor being programmed to visually display a customer indicator associated with said table selection;
said input processor being programmed to include and store in said electronic memory:
a first step of receiving a first input comprising actuation of one of said table selections;
a second step of receiving a second input comprising actuation of one of said customer indicators;
a third step of receiving a third input comprising one or more actuations of said food menu selections associated with prior actuation of one of said customer indicators and allowing said second and third steps to be repeated; and
a fourth step of converting all stored actuations of said first, second and third steps into said food order information and wirelessly sending said food order information to said hub.
